(19) United States
(12) Patent Application Publication
(10) Pub. No.: US 2026/0212264 A1
(43) Pub. Date: Jul. 23, 2026

(54) HYBRID LINEAR MACHINE LEARNING MODEL

(71) Applicant: Huawei Technologies Co., Ltd., Shenzhen (CN)

(72) Inventors: Yufei Cui, Brossard (CA); Xinyu Wang, Montreal (CA); Peng Lu, Kanata (CA); Boxing Chen, Ottawa (CA)

(21) Appl. No.: 19/178,517

(22) Filed: Apr. 14, 2025

Related U.S. Application Data
(60) Provisional application No. 63/748,315, filed on Jan. 22, 2025.

(51) Int. Cl. G06N 20/00

(52) U.S. Cl. CPC G06N 20/00

(57) ABSTRACT

A hybrid machine learning model architecture that enhances the retrieval capabilities of recurrent models without compromising efficiency. A linear recurrent architecture is supplemented by a parallel retrieval branch that integrates retrieved knowledge into the model with relatively minimal computational overhead. The parallel retrieval branch operates alongside the primary recurrent processing pipeline. The parallel retrieval branch chunks the input sequence and embeds the chunks into one or more pool. Chunk-by-chunk causal retrieval produces results that are then injected into the primary linear pipeline using within-chunk cross-attention.

### CROSS-REFERENCE TO RELATED APPLICATIONS

The present application claims priority to U.S. Provisional Patent Application No. 63/748,315 filed Jan. 22, 2025, the contents of which are hereby incorporated by reference.

### TECHNICAL FIELD

The present application relates to a machine learning model architecture and, in particular, a hybrid linear machine learning model.

### BACKGROUND

Machine learning models advanced tremendously with the introduction of transformer-based models. An example of a transformer-based model is a large language model (LLM) such as ChatGPT. LLMs based on transformer self-attention have demonstrated remarkable success across a wide range of tasks in both industrial and academic settings. Self-attention transformers provide a mechanism in machine learning that allows models to weigh the relevance of different parts of an input sequence in relation to each other. They capture dependencies and relationships among elements in the sequence, enabling LLMs and other architectures to focus on the most critical information within the input. Their ability to capture long-range dependencies and complex patterns has made them indispensable. However, the computational cost of transformers poses significant challenges. Both memory and time complexity grow quadratically with the input sequence length, leading to O(N²) complexity during training and O(N) complexity during inference. This constraint limits their scalability in resource-constrained environments.

To address these challenges, linear models have emerged as a popular alternative. These models use efficient mechanisms like linear attention or recurrence to process large-scale data with minimal computational overhead, enabling scalability for tasks involving long sequences. These types of models are designed to enhance efficiency, achieving O(N) complexity in training and O(1) complexity in inference. These models utilize innovative parametrizations to efficiently extract historical information and deliver competitive performance on many tasks. However, they struggle with in-context learning (ICL), particularly on tasks requiring robust copying mechanisms. This limitation arises because linear models lack robust mechanisms for efficiently managing and retrieving past context, often due to their constrained hidden state capacity.

### SUMMARY

In accordance with one aspect, the present application describes method of processing an input using a hybrid machine learning model. The method may include, in parallel with processing the input using one or more layers of linear recurrent processing, chunking the input into partitioned elements, tokenizing each partitioned element into a vector space, and performing causal retrieval for each partitioned element using the vector space, excluding partitioned elements later in the input, thereby obtaining retrieved values; and injecting the retrieved values into a subsequent layer of the hybrid machine learning model to be integrated with results from the one or more layers of linear recurrent processing.

In some implementations, the tokenizing includes tokenizing each partitioned element into the same vector space to create a common pool. In some cases, the input is a sequence and the chunking results in a sequence of partitioned elements, and excluding partitioned elements later in the input includes, while performing causal retrieval for each partitioned element, taking into account tokenized partitioned elements earlier in the sequence of partitioned elements and excluding tokenized partitioned elements later in the sequence of partitioned elements.

In some implementations, the input is a sequence and the chunking results in a sequence of partitioned elements, and the tokenizing includes creating a respective pool for each of the partitioned elements, and each respective pool includes its associated tokenized partitioned element and the tokenized partitioned elements earlier in the sequence of partitioned elements.

In some implementations, the causal retrieval is performed in parallel for all of the tokenized partitioned elements of the input.

In some implementations, the subsequent layer includes a chunk-based cross-attention operation into which the retrieved values are injected. In some cases, the chunk-based cross-attention operation focuses attention within each chunk.

In some implementations, the subsequent layer includes a self-reflection operation that receives the results from the one or more layers of linear recurrent processing. In some cases, the method further includes inputting an output of the chunk-based cross-attention operation and an output of the self-reflection operation into one or more further layers of the hybrid machine learning model to produce an output of the model based on the input. The output of the chunk-based cross attention layer outputs may include a cross-attention score and the output of the self-reflection layer may include a self-attention score. Inputting may include combining the cross-attention score and the self-attention score to produce a combined score that is input to the one or more further layers.

In another aspect, the present application describes a system to implement a machine learning model. The system may include one or more processors and memory, the memory storing processor-executable instructions that, when executed by the one or more processors, are to cause the one or more processors to carry out operations of one or more of the methods described herein.

In yet a further aspect, the present application describes a computer-readable medium storing computer-executable instructions that, when executed by one or more processors, are to cause the one or more processors to carry out any one or more of the methods described herein.

In another aspect, the present application describes a computer program comprising instructions which, when executed by a computing device, are to cause the computing device to carry out any one or more of methods described herein.

In a further aspect, the present application describes a computing device having means to perform any one or more of the methods described herein.

Other aspects and features of the present application will be understood by those of ordinary skill in the art from a review of the following description of examples in conjunction with the accompanying figures.

### BRIEF DESCRIPTION OF THE DRAWINGS

Reference will now be made, by way of example, to the accompanying drawings in which:

FIG. 1 diagrammatically illustrates an example of a portion of a hybrid linear machine learning model architecture;

FIG. 2 illustrates a chunk-and-search process for parallel retrieval;

FIG. 3 illustrates knowledge integration involving within-chunk cross-attention;

FIG. 4 diagrammatically illustrates an example architecture of a hybrid linear machine learning model;

FIG. 5 illustrates one example of a contextual search process;

FIG. 6 shows one example of a knowledge integration process;

FIG. 7 shows a high-level diagram of an example computing device; and

FIG. 8 shows a simplified example of software components within the computing device.

Like reference numerals are used in the drawings to denote like elements and features.

### DETAILED DESCRIPTION OF ILLUSTRATIVE EMBODIMENTS

Linear recurrent models introduce efficient architectures for sequence modeling. These models use linear layers to capture temporal information, achieving high efficiency in both training and inference. Their structure is optimized for scalability while maintaining strong modeling capabilities, making them suitable for processing long sequences.

As mentioned above, linear models struggle with in-context learning (ICL), particularly on tasks requiring robust copying mechanisms. This is because linear models cannot efficiently and effectively retrieve past context. Their constrained mechanisms for retrieving and utilizing past information, along with restricted hidden state capacity, make it challenging to manage increasing key-value pairs and handle complex dependencies effectively.

Some hybrid architectures have been developed to combine the strengths of attention mechanisms and linear layers to balance efficiency and modeling power. Examples include Jamba (Lieber et al., 2024), Samba (Ren et al., 2024), Zamba (Glorioso et al., 2024), and Mamba2Hybrid (Waleffe et al., 2024). These models integrate linear layers for temporal modeling with attention blocks to capture intricate dependencies. Sparse architectural enhancements, such as Mixture of Experts (MoE) and Sliding Window Attention (SWA), are often employed to optimize computational performance. Hybrid models try to balance the strengths of attention mechanisms and linear layers. However, they often fail to match the training speed of pure linear models and do not fully achieve the ICL effectiveness of standard transformer architectures. This results in trade-offs in efficiency and performance, particularly in tasks requiring precise retrieval and contextual reasoning.

In accordance with one aspect of the present application, a novel hybrid machine learning model architecture is proposed. This novel architectural solution enhances the retrieval capabilities of recurrent models without compromising efficiency, thereby enabling robust ICL applications. In one aspect, the present application modifies a linear recurrent architecture to add a parallel retrieval branch that integrates retrieved knowledge into the model with relatively minimal computational overhead. This design strengthens ICL while preserving the inherent speed advantages of recurrent architectures, offering an effective and efficient solution for improving context-based tasks. The parallel retrieval branch operates alongside the primary recurrent processing pipeline, enabling efficient knowledge integration without disrupting the model's processing flow.

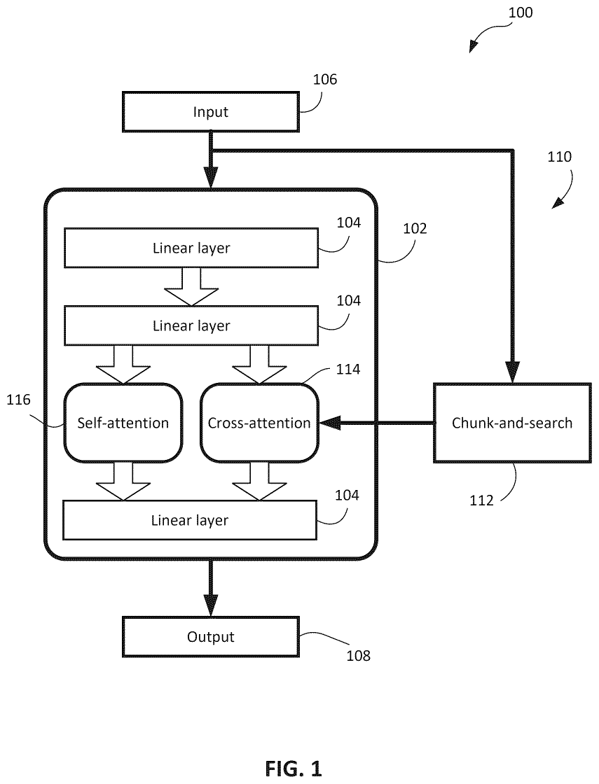

Reference is first made to FIG. 1, which diagrammatically illustrates an example of a portion of a hybrid linear machine learning model architecture 100. In this example, the architecture 100 includes a linear recurrent pipeline 102. The linear recurrent pipeline 102 may include a plurality of layers 104 configured to process data in a sequential manner. The architecture 100 receives a layer input 106 and produces a layer output 108. The layer input 106 may be from a query or prompt or from some earlier processing operation or layer in the overall machine learning model. The layer output 108 may be output as are response or result of the query or prompt, or may serve as an input to a further stage or layer of the machine learning model.

The architecture 100 further includes a parallel retrieval branch 110. This parallel retrieval branch 110 integrates retrieved knowledge from the layer input 106 into a later portion of the linear recurrent pipeline 102. This enables in-context learning within the recurrent processing flow without interrupting the primary linear recurrent pipeline 102.

The parallel retrieval branch 110 includes a chunk-and-search operation 112 that embeds each position of the input sequence in one or more index pools. In other words, it partitions the sequence into partitioned elements (e.g. chunks) and tokenizes each partitioned element into a vector space. A retrieval operation is then performed for each tokenized partitioned element (e.g. chunk) of the input sequence, in some cases in parallel, and the retrieved values are injected into the linear recurrent pipeline 102. The retrieval operation may be carried out in a causal manner such that each search operates independently and avoids sequential dependencies. That is, each search associated with a chunk only takes into account embedded chunks earlier in the input sequence.

Within the linear recurrent pipeline 102, the retrieved context (i.e. retrieved values) from the chunk-and-search operation 112 are integrated, as indicated by operation 114. In some implementations, this is carried out using a cross-attention mechanism. The operation 114 receives input from the preceding layer 104 and the retrieved values from the chunk-and-search operation 112 and, for each chunk, focusses attention within that retrieved chunk.

The values from the preceding layer 104 are also processed using a self-attention operation 116. The output of the knowledge integration operation 114 and the self-attention operation 116 may then be parameterized, combined, and passed to a subsequent layer 104 of the architecture 100.

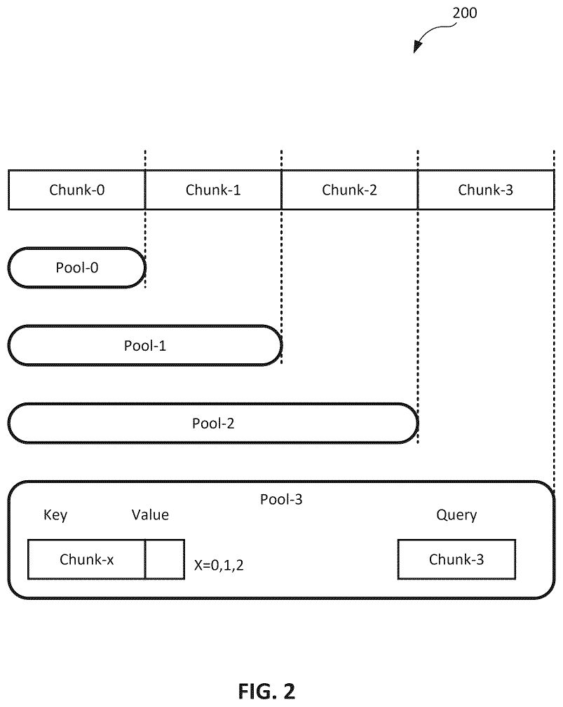

FIG. 2 diagrammatically illustrates the chunk-and-search process 200. As described above, the parallel retrieval branch may be implemented by way of a chunk-and-search process in which the input sequence is partitioned into partitioned elements (e.g. chunked) and embedded into one or many index pools. In some cases, a single large pool (e.g. a common pool) is constructed and then causal masking is used during the retrieval process to exclude later positions of the input sequence. In some cases, a separate index pool is constructed for each chunk that includes the embedded tokens of all preceding chunks of the input sequence. The example of FIG. 2 illustrates the case where a separate pool is generated for each chunk of the input sequence. In particular, for each position in the input sequence, a separate nearest neighbour search index pool is constructed.

The chunking of the input sequence may be done in accordance with whatever embedding model is used for a particular implementation.

As illustrated, in this example, a portion of the input sequence is shown partitioned into Chunk-0, Chunk-1, Chunk-2, and Chunk-3. Chunk-0 is embedded using the applicable embedding model. As there are no previous positions in the sequence, Pool-0 is effectively empty. Chunk-1 is embedded and the tensor of Chunk-0 forms Pool-1. Pool-2 then contains tensors for Chunk-0 and Chunk-1. Pool-3 contains tensors for Chunk-0, Chunk-1, and Chunk-2, and so on.

The search and/or retrieval operation in each pool is carried out by way of nearest neighbour index search.

In the case where there is a one large index pool, the search may nevertheless be carried out to achieve a similar effect through use of causal masking during the searches. That is, the search with regard to a particular chunk may ignore information from indices larger than the current chunk index. This may prevent information leakage during both training and inference.

The search and retrieval operations are performed in parallel for every position and chunk option. The operation is carried out so as to avoid sequential dependencies. The resulting values are used as input to the model at subsequent layers. As noted above, the retrieval results may be used in a cross-attention mechanism interjected within the linear pipeline.

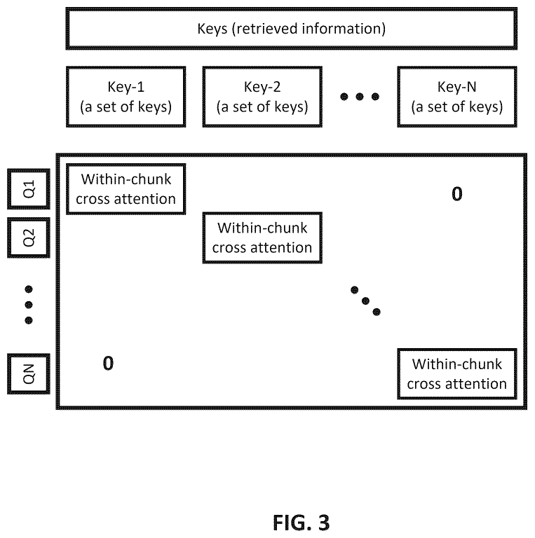

FIG. 3 diagrammatically illustrates knowledge integration involving within-chunk cross-attention.

As mentioned above, retrieved context (in this example, a set of “keys” for each chunk) is injected into the model at a middle layer using cross-attention. This approach focuses attention within each chunk, ensuring fixed attention calculations for each position in the sequence. By limiting the scope of attention to each chunk, computational overhead is reduced while maintaining focus on the most relevant context.

As shown in FIG. 3, query 1 (Q1) is associated with a first chunk and its associated retrieved context from the chunk-and-search operation, which in this example is a set of keys. These are combined in a cross-attention operation. Query 2 (Q2) is combined with the second set of keys (Key-2) in its own cross-attention operation, and so one. The within-chunk cross-attention operation builds a diagonal matrix of results of the cross-attention operations.

Referring again to FIG. 1, the self-attention operation 116 and the knowledge integration operation 114 are parameterized, allowing the model to learn how to effectively combine the retrieved context with the sequential information processed in the primary linear recurrent pipeline 102. That learnable integration ensures that the retrieved context is used optimally for downstream tasks.

The combined outputs of the self-attention operation 116 and the knowledge integration operation 114 are merged and passed to subsequent layers 104, thereby ensuring that the retrieved context contributes meaningfully to the model's representations.

The outputs of the self-attention operation 116 and the knowledge integration operation 114 may be weighted using weight_cross and weight_self to produce relative n-dimensional output vectors which may then be translated in respective scores score_cross and score_self. Thes may then be combined to obtain a combined score. In one example, the combined score is a concatenation of score_cross and score_self. In another example, the combined score may be combined using a relative weighting factor, α, in an expression such as: score_cross(α)+score_self(1−α).

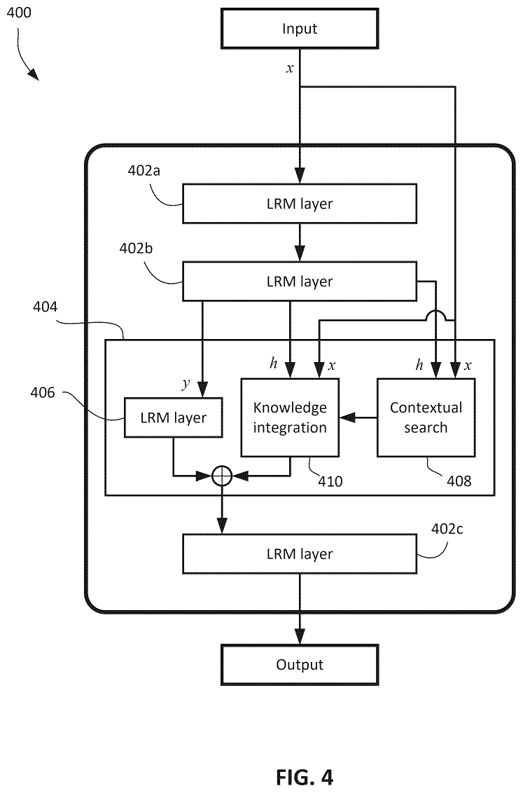

Reference will now be made to FIG. 4, which diagrammatically illustrates an example architecture 400 of a hybrid linear machine learning model. Is illustrated in this example, the architecture 400 includes a plurality of linear recurrent model (LRM) layers 402 (shown as 402a, 402b, 402c). The architecture 400 receives an input x. The LRM layers 402 may be typical LRMs which compress input within a unified hidden representation/state. The architecture 400 further includes at least one augmented layer 404. The augmented layer includes an LRM layer 406 but further includes a contextual search 408 process and a knowledge integration 410 process. The contextual search 408 obtains contextual information from the input x and the hidden state of the model as provided by the previous LRM layer 402b, and produces retrieved contextual information that is injected into the knowledge integration 410 process. The knowledge integration 410 process uses cross-attention to mix in the most relevant information from the retrieved contextual information with the hidden state of the previous LRM layer 402b to produce a retrieval-based output y^{r}. The retrieval-based output y^{r} is then combined with the model-based output y^{m} of the adjacent LRM layer 406 to obtain an output y.

The contextual search 408, e.g. chunk-and-search, operates on the input x to obtain contextually-relevant information, given the hidden state h of the model output by the previous LRM layer 402b. The knowledge integration 410 process receives hidden state h information from the previous LRM layer 402b and a mask computed from the contextual search 408. Both processes are described in greater detail below.

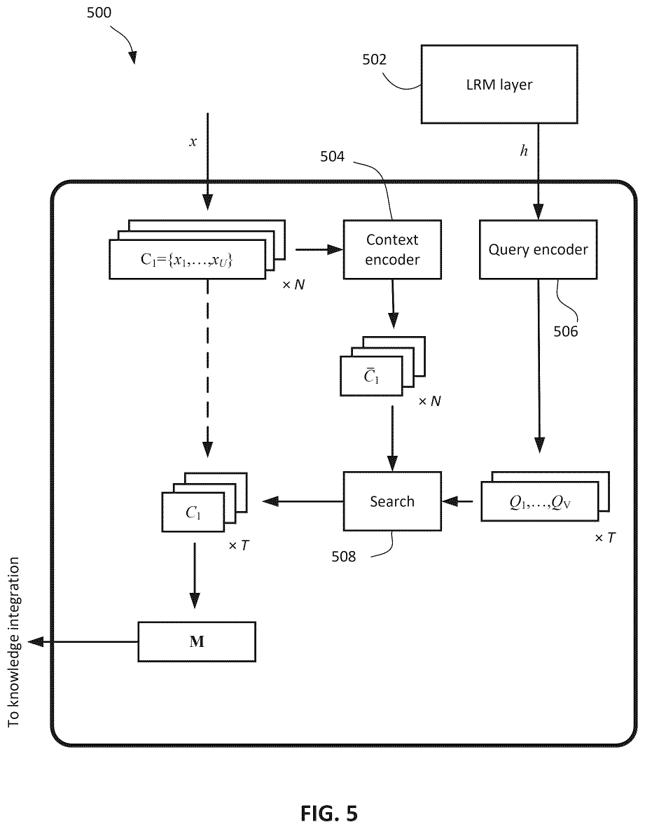

FIG. 5 diagrammatically illustrates one example of a contextual search 500 process. The contextual search 500 process receives hidden state h information from a previous LRM layer 502 and initial input x. The initial input x is the initial input to the overall hybrid model. As mentioned above, the contextual search 500 employs a chunk-and-search approach. The initial input x is split into N chunks, each having U tokens, to create x′∈ [symbol] ^{N×U×D}. Each of the chunks, Cᵢ, is encoded using a context encoder 504 to produce a context embedding C̅ᵢ.

The hidden state from the adjacent previous LRM layer 502, h∈ [symbol] ^{T×H}, is used to encode a number of queries into query embeddings, Q̅_{i:T}, using a query encoder 506.

The query embeddings and the context embeddings are input to a search 508 function. For each query, the search 508 may identify a top-k similar contexts from the context embeddings C̅ᵢ. In some cases, the search 508 is a cosine-similarity search. The results of the search 508 are chunk indices, I_{i:T}. The chunk indices may be used to retrieve the relevant input token positions, which are then used to create a mask M∈ [symbol] ^{T×T}. The mask is then input to the knowledge integration module for use in cross-attention.

In algorithmic form, the contextual search 500 process may be described as:

1. Input: Input x ∈ [symbol] ^{T×D} and LRM hidden state h ∈ [symbol] ^{T×H}; Output: Atten-
tion mask M ∈ [symbol] ^{T×T}
2. Chunk x into x′ ∈ [symbol] ^{N×U×D}
3. Encode each context chunk x′ into context embeddings C̅ ∈ [symbol] ^{N×E}
4. Encode h into query embeddings Q̅ ∈ [symbol] ^{T×E}
$5. Compute chunk index sets for each {\overline{Q}}_{j} : {\{ {I}_{j} \}}_{j = 1}^{T} = {\{ Topk ( {\overline{Q}}_{j} , \overline{C} ) \}}_{j = 1}^{T}$
$6. With {\{ {I}_{j} \}}_{j = 1}^{T} , compute a mask M ∈ {ℝ}^{T \times T} such that {M}_{ij} = 1 ⇔ ( i ∈ \{ {I}_{j} \} )$

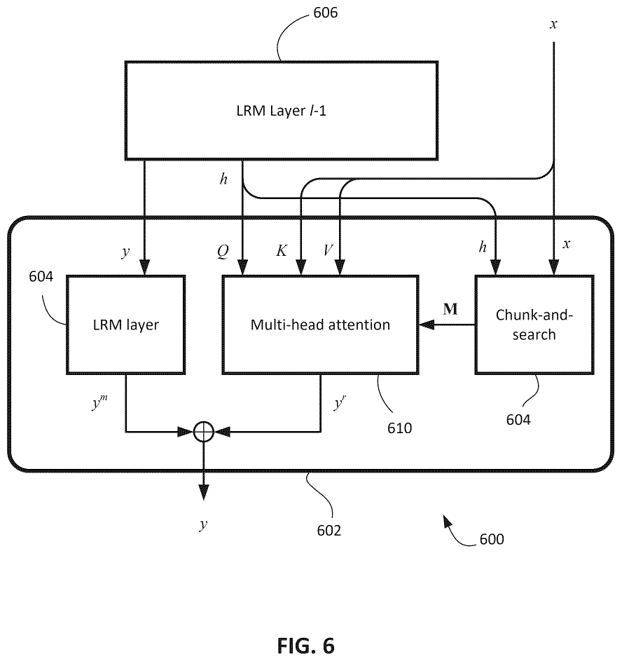

Reference is now made to FIG. 6, which shows one example of a knowledge integration 600 process. The knowledge integration 600 process is implemented at an augmented layer 602 of the model architecture. It operates in parallel to an adjacent LRM layer 608 within the augmented layer. A preceding LRM layer 606, LRM layer l−1, provides output data y and hidden state data h to the augmented layer 602.

The hidden state data h and original input data x are used by a chunk-and-search 604 operation, i.e. contextual search, to generate a mask M. The mask is input to a knowledge integration module, which in this example is implemented as a multi-head attention 610 module, e.g. a cross-attention module. The hidden state h is used as queries Q, and the original input embeddings x provide keys K and values V. Within the multi-head attention 610 module, the mask M ensures that only the most relevant information from the input is mixed into the cross-attention operation. The resulting output from the multi-head attention 610 module is y^{r}∈ [symbol] ^{T×D}.

The output y^{r} is then integrated, e.g., combined, with the output of the adjacent LRM layer, y^{m}, to produce an output y from the augmented layer 602. The combination may be, in some cases, given by:

$$y = α \cdot {y}^{m} + ( 1 - α ) \cdot {y}^{r}$$

In this example, α may be computed on an input-dependent basis for each element of y or may be set as a fixed hyper-parameter value. Because the chunk-and-search 604 operation ensures that each query in the multi-head attention 610 module attends to at most kU elements from the initial input in k contiguous blocks, the attention output y^{r} may be determined with computational efficiency using sparse attention mechanisms.

In algorithmic form, the knowledge integration 600 process may be described as:

```
1. Input: Input x ∈ [symbol] ^{T×D}, LRM hidden state h RTXH, mask M ∈ [symbol] ^{T×H};
  Output: y^{r} ∈ [symbol] ^{T×D}
2. From h, compute queries Q ∈ [symbol] ^{T×d}^{ₖ} using W_{Q}. Simultaneously,
  compute keys and values, K, V ∈ [symbol] ^{T×d}^{ₖ} from the input x
3. Compute an attention output 0 ∈ [symbol] ^{T×d}^{ₖ} as
              O = CrossAttention(Q, K, V, M)
4. Project O using Wₒᵤₜ into y^{r} ∈ [symbol] ^{T×D}.
```

In the above-described algorithm, the attention projection weights are given as W_{Q}, W_{K}, W_{V} and the output projection weights are Wₒᵤₜ.

As noted above, the auto-regressive nature of the model implies that a causal mask be employed during training. To maintain this during the parallel nature of training, for the query at index I, only chinks that contain information prior to that position in the input are considered. This ensures that the mask M does not reflect information from future tokens in a representation from the past.

During inference, the context is dynamically chunked based on a predefined chunk size. Once enough tokens are accumulated, a new chunk is created and the token are embedded into vectors and stored in a chunked cache. This process runs in parallel to the main model's token embedding, ensuring no additional latency. For long prompt inputs during the first forward pass, chunking may integrate within the pre-filling stage of the main branch, avoiding latency overhead. As a result, the chunking process aligns with the token embedding pipeline, operates less frequently, and shares the pre-filling stage, making it computationally efficient.

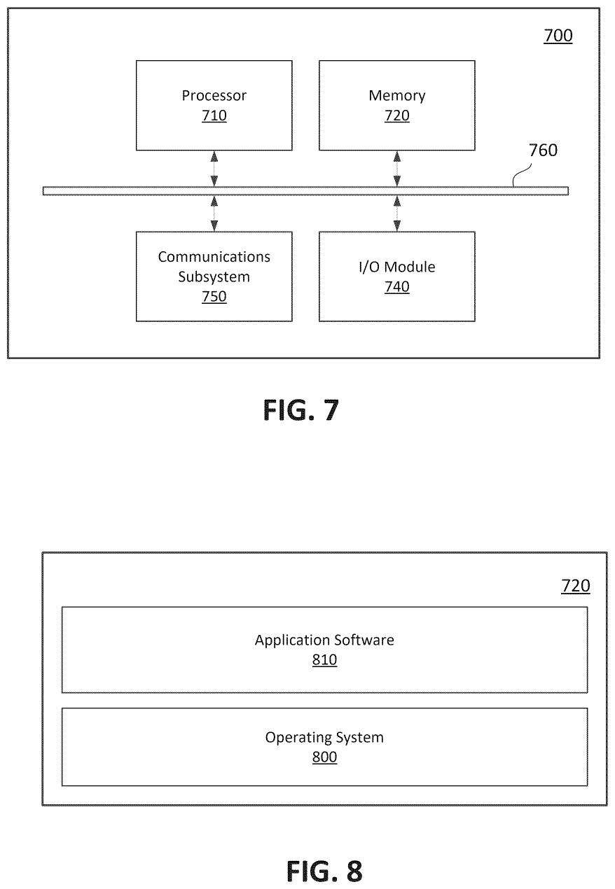

Reference will now be made to FIG. 7, which shows a high-level diagram of an example computing device 700. The example computing device 700 includes a variety of modules. For example, the example computing device 700 may include a processor 710, a memory 720, an I/O module 740, and a communications module 750. As illustrated, the foregoing example modules of the example computing device 700 are in communication over a bus 760.

The processor 710 in this example is a hardware processor. The processor 710 may, for example, be one or more ARM, Intel x86, PowerPC processors, or the like.

The memory 720 allows data to be stored and retrieved. The memory 720 may include, for example, random access memory, read-only memory, and persistent storage. Persistent storage may be, for example, flash memory, a solid-state drive or the like. Read-only memory and persistent storage are a computer-readable medium. A computer-readable medium may be organized using a file system such as may be administered by an operating system governing overall operation of the example computing device 700.

The I/O module 740 allows the example computing device 700 to receive input signals and to transmit output signal. Input signals may, for example, correspond to input received from a user. Some output signals may, for example, allow provision of output to a user. The I/O module 740 may serve to interconnect the example computing device 700 with one or more input devices. Input devices may, for example, include one or more of a touchscreen input, keyboard, trackball or the like. The I/O module 740 may serve to interconnect the example computing device 700 with one or more output devices. Output devices may include, for example, one or more display screens such as, for example, a liquid crystal display (LCD), a touchscreen display. Additionally, or alternatively, output devices may include devices other than screens such as, for example, a speaker, indicator lamps (such as, for example, light-emitting diodes (LEDs)), and printers.

The communications module 750 allows the example computing device 700 to communicate with other electronic devices and/or various communications networks. For example, the communications module 750 may allow the example computing device 700 to send or receive communications signals. As an example, the communication module 750 may include a network connection, data port, or the like. Communications signals may be sent or received according to one or more protocols or according to one or more standards. For example, the communications module 750 may allow the example computing device 700 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE), 5G, 6G, or the like. Additionally, or alternatively, the communications module 750 may allow the example computing device 700 to communicate using near-field communication (NFC), via Wi-Fi™, via the Ethernet family of network protocols, using Bluetooth™ or via some combination of one or more networks or protocols. In some embodiments, all or a portion of the communications module 750 may be integrated into a component of the example computing device 700. In some examples, the communications module may be integrated into a communications chipset.

Software instructions are executed by the processor 710 from a computer-readable medium. For example, software may be loaded into random-access memory from persistent storage within memory 720. Additionally, or alternatively, instructions may be executed by the processor 710 directly from read-only memory of the memory 720.

FIG. 8 depicts a simplified organization of software components stored in memory 720 of the example computing device 700. As illustrated, these software components include, at least, application software 810 and an operating system 800.

The application software 810 adapts the example computing device 700, in combination with the operating system 800, to operate as a device performing a particular function. While a single application software 810 is illustrated in FIG. 8, in operation, the memory 720 may include more than one application software and different application software may perform different operations.

The operating system 800 is software. The operating system 800 allows the application software 810 to access the processor 710, the memory 720, the I/O module 740, and the communications module 750. The operating system 800 may, for example, be iOS™, Android™, Linux™, Microsoft Windows™, or the like.

The application software 810 and/or operating system 800 may, when executed, cause the processor 710 to carry out operations to implement at least some portion of one or more of the methods described herein.

In the present disclosure, the terms “a”, “an” and “one” are defined to mean “at least one”, that is, these terms do not exclude a plural number of items, unless stated otherwise.

In the present disclosure, terms such as “substantially”, “generally” and “about”, which modify a value, condition or characteristic of a feature of an embodiment, should be understood to mean that the value, condition or characteristic is defined within tolerances that are acceptable for the proper operation of this embodiment for its intended application.

In the present disclosure, unless stated otherwise, the terms “connected” and “coupled”, and derivatives and variants thereof, refer herein to any structural or functional connection or coupling, either direct or indirect, between two or more elements. For example, the connection or coupling between the elements can be acoustical, mechanical, optical, electrical, thermal, logical, or any combinations thereof.

In the present disclosure, expressions such as “match”, “matching” and “matched”, including variants and derivatives thereof, are intended to refer herein to a condition in which two or more elements are either the same or within some predetermined tolerance of each other. That is, these terms are meant to encompass not only “exactly” or “identically” matching the two elements but also “substantially”, “approximately” or “subjectively” matching the two or more elements, as well as providing a higher or best match among a plurality of matching possibilities.

In the present disclosure, the expression “based on” is intended to mean “based at least partly on”, that is, this expression can mean “based solely on” or “based partially on”, and so should not be interpreted in a limited manner. More particularly, the expression “based on” could also be understood as meaning “depending on”, “representative of”, “indicative of”, “associated with” or similar expressions.

In the present disclosure, the terms “system” and “network” may be used interchangeably in embodiments of this application. “At least one” means one or more, and “a plurality of” means two or more. The term “and/or” describes an association relationship of associated objects and indicates that three relationships may exist. For example, A and/or B may indicate the following three cases: Only A exists, both A and B exist, and only B exists, where A and B may be singular or plural. The character “/” usually indicates an “or” relationship between associated objects. “At least one of the following items (pieces)” or a similar expression thereof indicates any combination of these items, including a single item (piece) or any combination of a plurality of items (pieces). For example, “at least one of A, B, or C” includes A, B, C, A and B, A and C, B and C, or A, B, and C, and “at least one of A, B, and C” may also be understood as including A, B, C, A and B, A and C, B and C, or A, B, and C. In addition, unless otherwise specified, ordinal numbers such as “first” and “second” in embodiments of this application are used to distinguish between a plurality of objects, and are not used to limit a sequence, a time sequence, priorities, or importance of the plurality of objects.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements. The term “and/or” is intended to indicate that either of the two elements may be included or both of the elements may be included.

A person skilled in the art will understand that embodiments of this application may be provided as a method, an apparatus (or system), a computer-readable storage medium, or a computer program product. Therefore, this application may use a form of a hardware-only embodiment, a software-only embodiment, or an embodiment with a combination of software and hardware. Moreover, this application may use a form of a computer program product that is implemented on one or more computer-usable storage media (including but not limited to a disk memory, an optical memory, and the like) that include computer-usable program code.

This application is described with reference to the flowcharts and/or block diagrams of the method, the device (system), and the computer program product according to this application. It should be understood that computer program instructions may be used to implement each process and/or each block in the flowcharts and/or the block diagrams and a combination of a process and/or a block in the flowcharts and/or the block diagrams. The computer program instructions may be provided for a general-purpose computer, a dedicated computer, an embedded processor, or a processor of another programmable data processing device to generate a machine, so that the instructions executed by the computer or the processor of the another programmable data processing device generate an apparatus for implementing a specific function in one or more procedures in the flowcharts and/or in one or more blocks in the block diagrams.

The computer program instructions may alternatively be stored in a computer-readable memory that can indicate a computer or another programmable data processing device to work in a specific manner, so that the instructions stored in the computer-readable memory generate an artifact that includes an instruction apparatus. The instruction apparatus implements a specific function in one or more procedures in the flowcharts and/or in one or more blocks in the block diagrams.

The computer program instructions may alternatively be loaded onto a computer or another programmable data processing device, so that a series of operations and steps are performed on the computer or the another programmable device, so that computer-implemented processing is generated. Therefore, the instructions executed on the computer or the another programmable device provide steps for implementing a specific function in one or more procedures in the flowcharts and/or in one or more blocks in the block diagrams.

It will be understood that a person skilled in the art may make various modifications and variations to this application without departing from the scope of this application. This application is intended to cover these modifications and variations of this application provided that they fall within the scope of protection defined by the following claims and their equivalent technologies.

Throughout the present disclosure, a processor, a processor system, an application processor, a baseband processor, a processor circuit, or a processor core may be collectively referred to as a processor. A processor may include one or more of a central processing unit (CPU), a digital signal processor (DSP), a microprocessor unit (MPU), a microcontroller unit, (MCU), a graphics processing unit (GPU), a field programmable gate array (FPGA), an artificial intelligence (AI) processor, or a neural network processing unit (NPU), or a combination of at least two of these integrated circuit forms.

Throughout the present disclosure, a memory may include one or more of the following storage media: a RAM, a static random access memory (SRAM), a dynamic random access memory (DRAM), a phase-change memory (PCM), a resistive random access memory (ReRAM), a magnetoresistive random access memory (MRAM), a ferroelectric random access memory (FRAM), a cache, a register, a read-only memory (ROM), a flash memory, an erasable programmable read-only memory (EPROM), a hard disk, and/or the like. In an example, the computer program instructions used to execute embodiments contained herein may be stored in a non-volatile memory. When a terminal runs, part or all of corresponding computer program instructions may be loaded into a memory that has a higher transmission speed with a corresponding processor, for example, the instructions may be loaded into at least a part of a memory such that the processor executes the computer program instructions to perform the steps in of embodiments described herein.

The various embodiments presented above are merely examples and are in no way meant to limit the scope of this application. Variations of the innovations described herein will be apparent to persons of ordinary skill in the art, such variations being within the intended scope of the present application. In particular, features from one or more of the above-described example embodiments may be selected to create alternative example embodiments including a sub-combination of features which may not be explicitly described above. In addition, features from one or more of the above-described example embodiments may be selected and combined to create alternative example embodiments including a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

What is claimed is:

1. A method of processing an input using a hybrid machine learning model, the method comprising:
in parallel with processing the input using one or more layers of linear recurrent processing,
chunking the input into partitioned elements,
tokenizing each partitioned element into a vector space, and
performing causal retrieval for each partitioned element using the vector space, excluding partitioned elements later in the input, thereby obtaining retrieved values; and
injecting the retrieved values into a subsequent layer of the hybrid machine learning model to be integrated with results from the one or more layers of linear recurrent processing.

2. The method of claim 1, wherein the tokenizing includes tokenizing each partitioned element into the same vector space to create a common pool.

3. The method of claim 2, wherein the input is a sequence and the chunking results in a sequence of partitioned elements, and wherein excluding partitioned elements later in the input includes, while performing causal retrieval for each partitioned element, taking into account tokenized partitioned elements earlier in the sequence of partitioned elements and excluding tokenized partitioned elements later in the sequence of partitioned elements.

4. The method of claim 1, wherein the input is a sequence and the chunking results in a sequence of partitioned elements, and wherein the tokenizing includes creating a respective pool for each of the partitioned elements, and wherein each respective pool includes its associated tokenized partitioned element and the tokenized partitioned elements earlier in the sequence of partitioned elements.

5. The method of claim 1, wherein the causal retrieval is performed in parallel for all of the tokenized partitioned elements of the input.

6. The method of claim 1, wherein the subsequent layer includes a chunk-based cross-attention operation into which the retrieved values are injected.

7. The method of claim 6, wherein the chunk-based cross-attention operation focuses attention within each chunk.

8. The method of claim 6, wherein the subsequent layer includes an adjacent linear recurrent model (LRM) layer that receives the results from the one or more layers of linear recurrent processing.

9. The method of claim 8, further comprising combining an output of the chunk-based cross-attention operation and an output of the adjacent LRM layer to create an output that is input into a further layer of the hybrid machine learning model to produce an output of the model.

10. The method of claim 9, wherein the output of the chunk-based cross attention layer and the output of the adjacent LRM layer are weighted based on a hyper-parameter value and are summed.

11. A system to implement a machine learning model, comprising:
one or more processors; and
memory storing processor-executable instructions for processing an input using a hybrid machine learning model, wherein the instructions, when executed by the one or more processors, are to cause the one or more processors to:
in parallel with processing the input using one or more layers of linear recurrent processing,
chunk the input into partitioned elements,
tokenize each partitioned element into a vector space, and
perform causal retrieval for each partitioned element using the vector space, excluding partitioned elements later in the input, thereby obtaining retrieved values; and
inject the retrieved values into a subsequent layer of the machine learning model to be integrated with results from the one or more layers of linear recurrent processing.

12. The system of claim 11, wherein the instructions, when executed, are to cause the one or more processors to tokenize at least in part by tokenizing each partitioned element into the same vector space to create a common pool.

13. The system of claim 12, wherein the input is a sequence and the chunking results in a sequence of partitioned elements, and wherein the instructions, when executed, are to cause the one or more processors to exclude partitioned elements later in the input at least in part by:
while performing causal retrieval for each partitioned element, taking into account tokenized partitioned elements earlier in the sequence of partitioned elements and excluding tokenized partitioned elements later in the sequence of partitioned elements.

14. The system of claim 11, wherein the input is a sequence and the chunking results in a sequence of partitioned elements, and wherein the instructions, when executed, are to cause the one or more processors to tokenize at least in part by creating a respective pool for each of the partitioned elements, and wherein each respective pool includes its associated tokenized partitioned element and the tokenized partitioned elements earlier in the sequence of partitioned elements.

15. The system of claim 11, wherein the causal retrieval is performed in parallel for all of the tokenized partitioned elements of the input.

16. The system of claim 11, wherein the subsequent layer includes a chunk-based cross-attention operation into which the retrieved values are injected.

17. The system of claim 16, wherein the chunk-based cross-attention operation focuses attention within each chunk.

18. The system of claim 16, wherein the subsequent layer includes an adjacent linear recurrent model (LRM) layer that receives the results from the one or more layers of linear recurrent processing.

19. The system of claim 18, wherein the instructions, when executed, are to further cause the one or more processors to combine an output of the chunk-based cross-attention operation and an output of the adjacent LRM layer to create an output that is input into a further layer of the hybrid machine learning model to produce an output of the model.

20. A non-transitory computer readable medium storing processor-executable instructions for processing an input using a hybrid machine learning model wherein the instructions, when executed by one or more processors, are to cause the one or more processors to:
in parallel with processing the input using one or more layers of linear recurrent processing,
chunk the input into partitioned elements,
tokenize each partitioned element into a vector space, and
perform causal retrieval for each partitioned element using the vector space, excluding partitioned elements later in the input, thereby obtaining retrieved values; and
inject the retrieved values into a subsequent layer of the machine learning model to be integrated with results from the one or more layers of linear recurrent processing.
